(19) United States
(12) Patent Application Publication
(10) Pub. No.: US 2012/0279537 A1
(43) Pub. Date: Nov. 8, 2012

(54) Tank Cleaning Unit

(75) Inventors: Brad J. Peeters, Menasha, WI (US); Kyle S. Heyrman, Green Bay, WI (US)

(73) Assignee: Veolia ES Industrial Services, Inc., League City, TX (US)

(21) Appl. No.: 13/098,577

(22) Filed: May 2, 2011

(51) Int. Cl. B08B 9/00

(52) U.S. Cl. 134/56 R

(57) ABSTRACT

A tank cleaning unit is movable within a storage tank and applies cleaning fluid from a fluid spray nozzle onto accumulated sludge or waste in the tank to clean the tank under control of a control system located externally of the storage tank. The unit is moved by drive motors mounted a transport chassis of the unit with guidance from remote control to clear a path toward a desired position in the tank with the cutter fluid spray. The unit applies cleaning fluid to the interior of the tank to clean the accumulated sludge or waste. The unit includes structure to prevent tangling of the supply and control conduits and conductors connecting it to the remote control system. The unit also provides improved stability while in the tank.

### BACKGROUND OF THE INVENTION

1. Field of the Invention

The present invention relates to cleaning of sludge and waste materials from the interior of storage tanks in petroleum refineries, chemical processing plants and the like.

2. Description of the Related Art

In the petroleum refining and petrochemical chemical industries large storage tanks are in common usage. Various processes cause waste materials, both solid and liquid, to be generated along with the desired products. The accumulation of such waste materials, or sludge, can occur in these large storage tanks. It is not uncommon to have several feet of such sludge in the bottom of a single such large storage tank. The sludge usually contains a fairly high percentage of hydrocarbons which can be recycled if separated from the solid irreducible waste which may comprise catalyst fines, rust or other particulate matter developed in a particular chemical process.

Large storage tanks of this type have been widely used in refineries and chemical plants. A typical range of diameter sizes for storage tanks has been from 20 to 150 feet or larger. Such tanks were generally closed to the atmosphere by floating or fixed roofs. The tanks typically stored noxious or aromatic liquids. During their service life, it has at times been desirable to convert storage tanks for storage of different liquids. Also, the tank may have become fouled by sediment resulting from a chemical process, or by rust, corrosion, or the like. In such cases, it became necessary to clean the interior of the tank.

With early tank cleaning methods, workers entered a tank from a manway or entry located near the bottom. The workers generally had to wear protective clothing and use respirators to protect themselves from fumes inside the tank. This severely limited the available work time inside the tank, particularly in warm weather. The workers used high pressure hoses and suction lines on the bottom of the tank, and applied high pressure water or diluent, such as diesel fuel or light crude oil, to the inside tank surfaces to clean them. This was dangerous and strenuous work.

More recently, attempts were made with robotic tank cleaning vehicles which were located in the tank and remotely controlled by operators with control systems located outside the tank. Examples of such robotic tank cleaning vehicles were those in U.S. Pat. Nos. 5,561,883; 5,642,745; and 5,740,821. However, so far as is known, robotic tank cleaning vehicles of these types have not been widely used or accepted, and there were apparent operational problems with them.

The hoses and cables which connected the robotic vehicle to the external control system and supplied the vehicle with cleaning fluid became tangled during movement or cleaning operations in the tank. This required either that a crew member put on protective gear to enter the tank and attempt to correct the problem, or removal of the robotic vehicle. Removal of the vehicle could be attempted under its own power and controls, or with the assistance of a crew member. This again required that the crew member put on protective gear and enter the tank.

Further, the maneuverability of prior robotic vehicles could be a problem. The vehicles used an endless track or belt to move the vehicle. In service, problems were encountered with binding or breaking of the belts or tracks, particularly in turning the vehicle or changing its course of travel.

### SUMMARY OF THE INVENTION

Briefly, the present invention provides a new and improved tank cleaning unit movable within a storage tank and applying cleaning fluid to waste material in the tank to clean the tank under control of a remote control system located externally of the storage tank. The tank cleaning unit includes a cleaning module with a cleaning fluid applicator receiving cleaning fluid through a fluid supply connection and spraying cleaning fluid into the waste material for cleaning purposes. The cleaning module also includes an illumination source mounted with the cleaning fluid applicator and emitting light into an area of the tank being sprayed with cleaning fluid from the cleaning fluid applicator. The illumination source is connected by an electrical supply conduit from the control system to receive operating power. An observation camera with the cleaning module forms images of the area of the tank being sprayed with cleaning fluid from the cleaning fluid applicator. The observation camera is connected by an electrical supply conduit to the control system to receive operating power and control signals and a signal transfer conduit to convey to the control system images of the area of the tank being sprayed. The tank cleaning unit also includes a cleaning platform which supports the cleaning fluid applicator, the illumination source and the observation camera, and a transport chassis for supporting the cleaning fluid module. A drive mechanism is mounted with the transport chassis for moving the transport chassis. At least one drive motor is mounted with the transport chassis and provides power the front drive mechanism. The drive motor receives operating power from a supply conduit connected from the control system to the transport chassis to move the chassis and cleaning module within the interior of the tank. A power transfer mechanism is mounted with the transport chassis between the drive motor and the drive mechanism. The cleaning module is movable with respect to the chassis from a lowered position for entry into the tank to a raised position for cleaning purposes, and a position adjustment mechanism mounted between the cleaning module and the chassis moves the cleaning module between the lowered and raised positions. The position adjustment mechanism receives operating power from a supply conduit connected from the control system to the chassis, and a conduit support frame mounted with the chassis supports the conduits extending between the chassis and the control system at spaced positions from each other during movement of the cleaning module and chassis.

The present invention also provides a new and improved tank cleaning unit movable within a storage tank and applying cleaning fluid to waste material in the tank to clean the tank under control of a control system located externally of the storage tank. The tank cleaning unit includes cleaning module which has a cleaning fluid applicator receiving cleaning fluid through a fluid supply connection and spraying cleaning fluid into the waste material for cleaning purposes. The cleaning module includes an illumination source mounted with the cleaning fluid applicator. The illumination source emits infrared light into an area of the tank being sprayed with cleaning fluid from the cleaning fluid applicator. The infrared light illumination source is connected by an electrical supply conduit from the control system to receive operating power. The cleaning module also includes an observation camera which forms images of the area of the tank being sprayed with cleaning fluid from the cleaning fluid applicator. The observation camera is connected by an electrical supply conduit to the control system to receive operating power and control signals and by a signal transfer conduit to convey to the control system images of the area of the tank being sprayed. The tank cleaning unit also includes a cleaning platform supporting the cleaning fluid applicator, the illumination source and the observation camera, and a transport chassis for supporting the cleaning fluid module. A drive motor moves the chassis and cleaning module within the interior of the tank. The cleaning module is movable with respect to the chassis from a lowered position for entry into the tank to a raised position for cleaning purposes. A position adjustment mechanism is mounted between the cleaning module and the chassis for moving the cleaning module between the lowered and raised positions. The position adjustment mechanism receives operating power from a supply conduit connected from the control system to the chassis A conduit support frame mounted with the chassis supports the conduits extending between the chassis and the control system at spaced positions from each other during movement of the cleaning module and chassis.

The present invention also provides a new and improved tank cleaning unit movable within a storage tank and applying cleaning fluid to waste material in the tank to clean the tank under control of a control system located externally of the storage tank. The tank cleaning unit includes a cleaning module having a cleaning fluid applicator receiving cleaning fluid through a fluid supply connection and spraying cleaning fluid into the waste material for cleaning purposes. The cleaning module also includes an illumination source mounted with the cleaning fluid applicator and emitting light into an area of the tank being sprayed with cleaning fluid from the cleaning fluid applicator. The illumination source is connected by an electrical supply conduit from the control system to receive operating power. The cleaning module includes an observation camera forming images of the area of the tank being sprayed with cleaning fluid from the cleaning fluid applicator. The observation camera is connected an electrical supply conduit to the control system to receive operating power and control signals. The observation camera is connected by a signal transfer conduit to convey to the control system images of the area of the tank being sprayed. The tank cleaning unit also includes a cleaning platform supporting the cleaning fluid applicator, the illumination source and the observation camera, and a transport chassis for supporting the cleaning fluid module. A power transfer mechanism is mounted with the transport chassis between the drive motor and the front and rear drive axles. The cleaning module is movable with respect to the chassis from a lowered position for entry into the tank to a raised position for cleaning purposes. A position adjustment mechanism mounted between the cleaning module and the chassis moves the cleaning module between the lowered and raised positions. The position adjustment mechanism receives operating power from a supply conduit connected from the control system to the chassis. Lateral stabilizers are mounted with the transport chassis and are movable outwardly to furnish lateral stability for the tank cleaning unit in the storage tank. The lateral stabilizers receive operating power from a supply conduit connected from the control system to the chassis. A conduit support frame mounted with the chassis supports the conduits extending between the chassis and the control system at spaced positions from each other during movement of the cleaning module and chassis.

### BRIEF DESCRIPTION OF THE DRAWINGS

FIG. 1 is an isometric view of a tank cleaning unit according to the present invention in a position to spray cleaning fluid.

FIG. 2 is a plan view of the tank cleaning unit of FIG. 1.

FIG. 3 is a side elevation view of the tank cleaning unit of FIG. 1.

FIG. 4 is a front view of the tank cleaning unit of FIG. 1.

FIG. 5 rear view of the tank cleaning unit of FIG. 1.

FIG. 6 is an isometric view of the tank cleaning unit of FIG. 1 in a position to enter a storage tank.

FIG. 7 is a plan view of the tank cleaning unit of FIG. 6.

FIG. 8 is a side elevation view of the tank cleaning unit of FIG. 6.

FIG. 9 is a bottom view of the tank cleaning unit of FIG. 6.

FIG. 10 is a functional block diagram of the tanks cleaning unit according to the present and its associated control system.

### DETAILED DESCRIPTION OF THE PREFERRED EMBODIMENTS

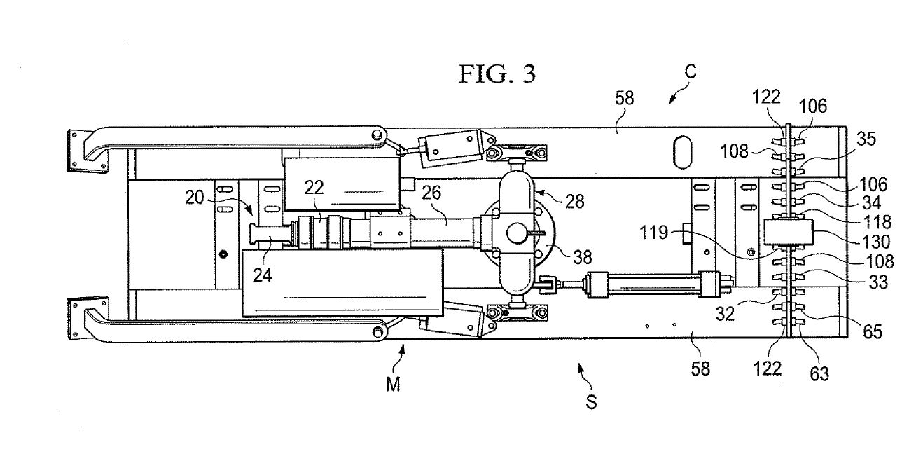

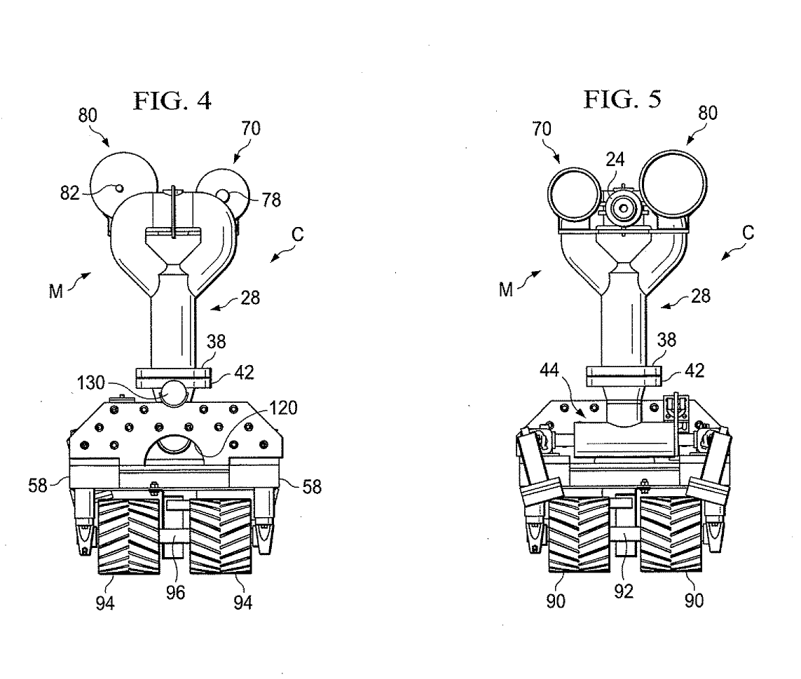

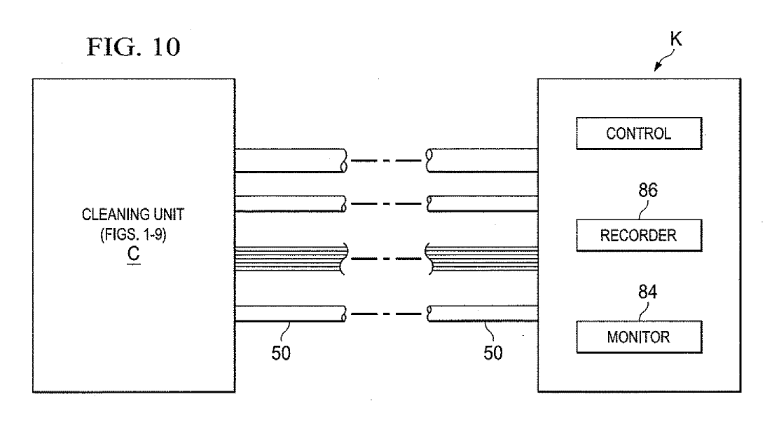

In the drawings, the letter C designates a tank cleaning unit according to the present invention. The tank cleaning unit C is movable within a storage tank and applies cleaning fluid to waste material in the tank to clean the tank. Tank cleaning operations by the unit C and movement within the tank are under control of a control system K (FIG. 10) located externally of the storage tank. The fluid supply and electrical connections between cleaning unit C and control system S are shown schematically in FIG. 3.

The tank cleaning unit C includes cleaning module M with a cleaning fluid applicator 20 which receives cleaning fluid or cutter stock through a fluid supply connection 22 from a fluid supply source external to the tank under control of the control system S. The cleaning fluid applicator 20 includes a fluid spray nozzle or cannon 24 which spray cleaning fluid under a desired amount of pressure into the waste material for cleaning purposes. The cleaning fluid is typically diesel fuel or some mixture based on diesel fuel, or other suitable heavy hydrocarbon waste material solvent, which may be heated if desired. In some cases, water or water based solvents might be used.

The cleaning fluid nozzle 24 is mounted at an outer end of a discharge pipe 26 which is pivotally connected at its inlet to a monitor assembly 28. A suitable monitor assembly is a Gemini Monitor Model 3475 available from Akron Brass Company of Wooster, Ohio, and a suitable nozzle is a Style 1417, size 15/16 also available from Akron Brass Company. It should be understood that other manifolds and nozzles could be used, if desired.

The nozzle 24 is steerable by fluid pressure over conduits 32 and 33 (FIG. 3) by a motor in a cleaning unit movement and operation control module K (FIG. 10) of the control system K to move either left or right and rotate substantially 360° in a horizontal plane. This permits the nozzle 24 to direct cleaning fluid about the interior of the storage tank being cleaned.

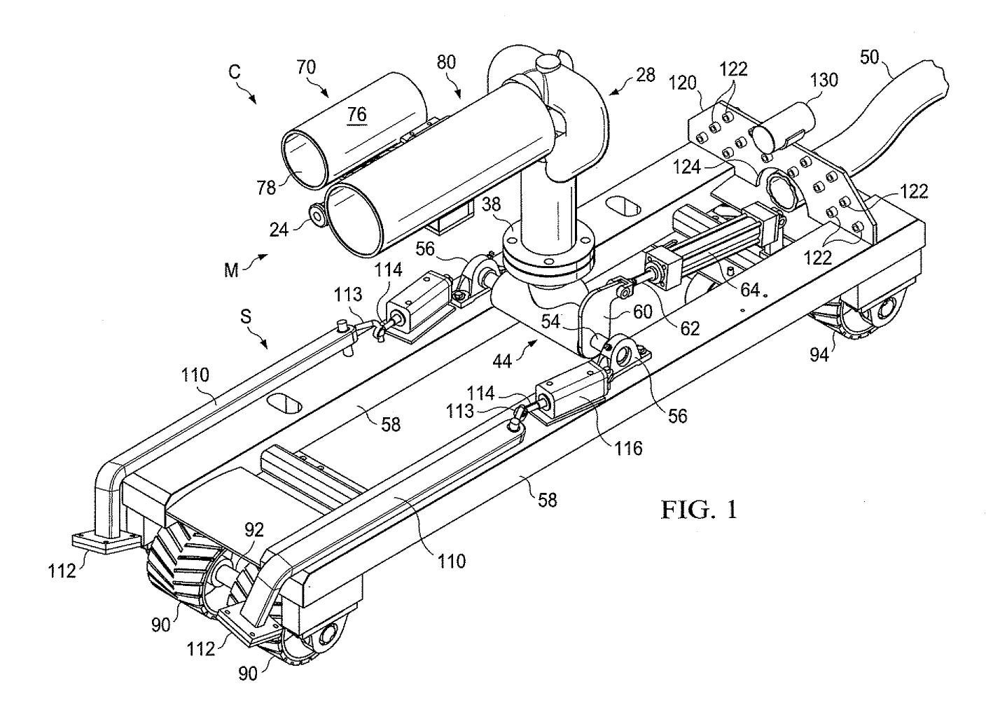

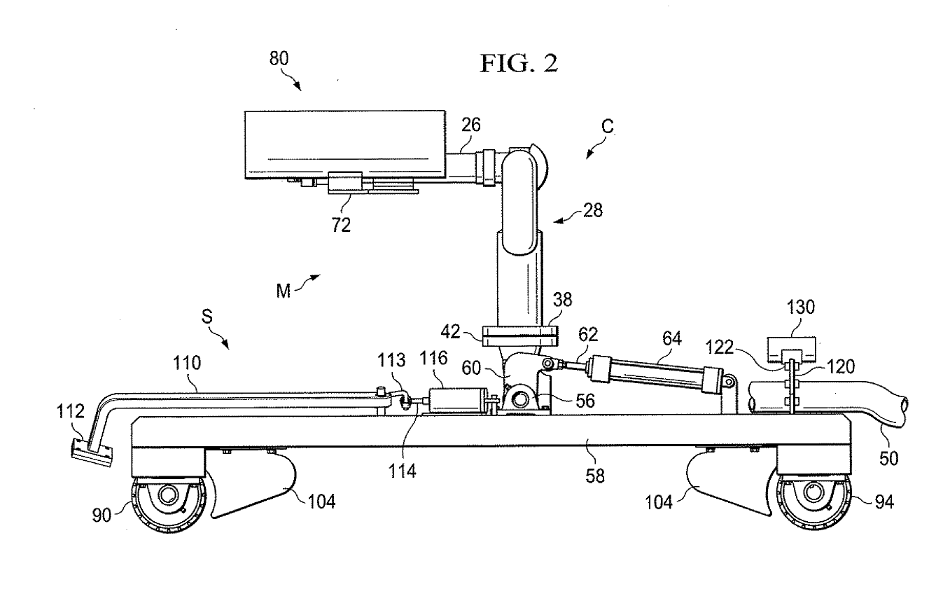

The nozzle 24 is also steerable by fluid over conduits 34 and 35 by a motor of the control module K to rotate either upwardly or downwardly in a vertical plane. The nozzle 24 is steerable from the horizontal position shown in-FIG. 1 to a substantially vertical 90° position, perpendicular to that of the horizontal spray cleaning position shown in Figure. 1. The nozzle 24 is also steerable to a depressed angle of about 45° below the horizontal plane of FIG. 1 to direct cleaning fluid about the lower interior and floor of the storage tank being cleaned. The motors for rotation and steering of the nozzle 24 are included within the nozzle, and are controlled externally by the control system K, as will be set forth.

The monitor assembly 28 is rotatably mounted at a lower end with a mounting flange 38 which is connected to a connector flange 42 of a fluid connector assembly 44. The fluid connector assembly 44 has a cleaning fluid inlet 46 and a fluid chamber 48 adapted to receive cleaning fluid through a supply hose 50 which conveys cleaning fluid from a supply external to the storage tank. Portions of the supply hose 50 are not shown in the drawings in order that other structure of the tank cleaning unit C may be more clearly seen,

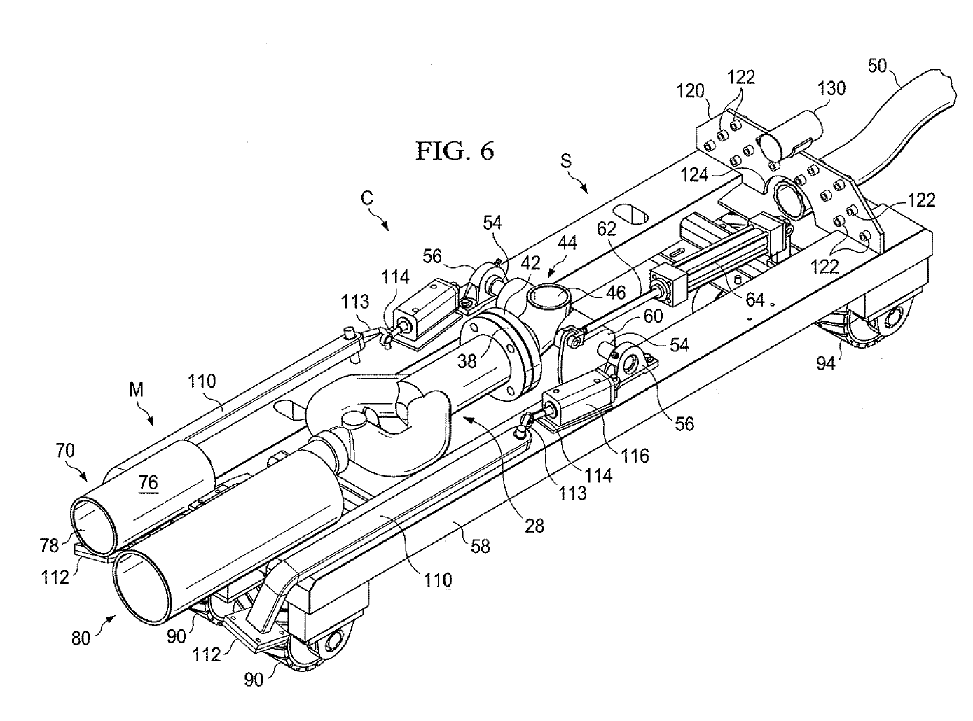

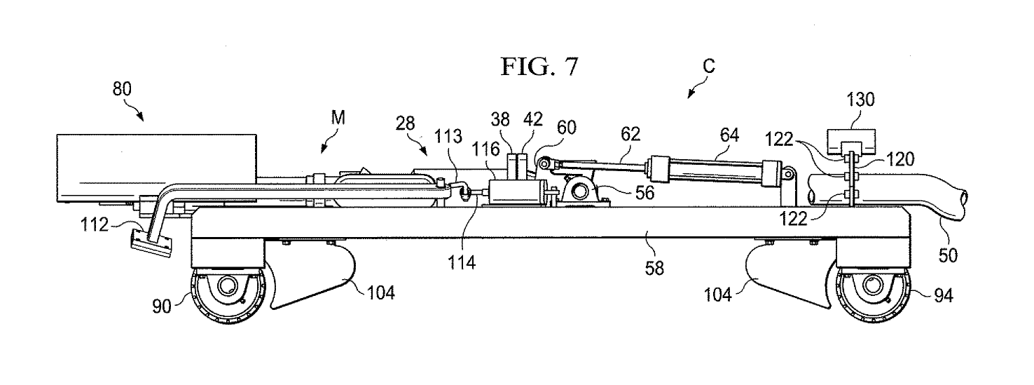

The fluid chamber 48 of the fluid connector assembly 44 is closed at each end by end plates 52 from which connector rods or shafts 54 extend outwardly. The connector shafts 54 are mounted in bearings 56 mounted on side beam members 58 of the transport chassis S. A linkage plate 60 of the fluid connector assembly 44 is mounted with one of the end plates 52 and is connected to an outer end of a piston shaft 62 which is operated by a position control piston or motor 64. The piston 64 is a hydraulically driven, solenoid actuated assembly operated under control of the control module K by fluid conduits 63 and 65 to move the shaft 62 and rotate the linkage plate 60 and fluid connector assembly 44. This movement in turn moves the monitor 28 and nozzle 24 of the cleaning module M to the entry position shown in FIG. 6 for entry and exit into the storage tank in through a manway or portal.

The piston 64 reverses the movement of shaft 62 in response to reverse flow of fluid through conduits 63 and 65 to move the cleaning module M to the raised or spraying position shown in FIG. 6. The piston 64, shaft 62, and linkage plate 60 thus adjust the position of the cleaning module M between the entry position (FIG. 6) for entry into the storage tank and the raised or spray cleaning position (FIG. 1) for spray cleaning operations.

The cleaning module M also includes an illumination source or lamp 70 mounted with the cleaning fluid applicator 20 on a platform 72 of the cleaning module M. The lamp or source 70 is positioned on the platform 72 adjacent the nozzle 24 and fluid supply connection 22 so that light is provided along the axis at which cleaning fluid is being sprayed by nozzle 24.

The illumination source 70 is mounted in a vapor sealed, corrosion resistant, explosion proof housing 76 for deployment in the storage tank. The illumination source 70 is preferably an infrared or IR illuminator which emits infrared light of a suitable infrared wavelength through a front plate or lens 78 onto the area of the tank being sprayed with cleaning fluid by nozzle 24. The illumination source 70 is connected by an electrical supply conduit 78 from the control module K receive operating power. If desired, intensity of the illumination output from lamp 70 may be adjusted by inclusion of a control connection with the control system S. A suitable illumination source lamp for the present invention is, for example, one from the DLZ69000 Series of infrared illumination sources available from Dante Security, Inc.

An observation camera 80 with the cleaning module M forms images of the area of the tank being sprayed with cleaning fluid from the cleaning fluid applicator nozzle 24. The camera 80 is also positioned with the lamp 70 on the platform 72 adjacent the nozzle 24 and fluid supply connection 22 so that conditions can be observed in the direction along which cleaning fluid is being sprayed by nozzle 24. This permits observation and monitoring during the tank cleaning operation.

The observation camera 80 is preferably a high resolution digital television camera of the type used for closed circuit television monitoring operations. The camera 80 is connected by an electrical supply conduit 82 to the external control system for camera 80 to receive operating power; control signals, such as camera lens focus, lens and image adjustment and the like; and signal transfer connections to convey images to the control system K of the area of the tank being sprayed. A suitable camera for the present invention is, for example, a Model CCC1390H available from Delco of Schneider Electric. Images of the progress of tank cleaning are conveyed by the conduit 82 to a display or video monitor 84 (FIG. 10) of the control system K. The images from the tank made by the camera 80 are also stored in a suitable memory, such as a DVR recorder 86.

If desired, a digital computer may also be provided with the control system K to receive and store digital data and images, as well as records of equipment settings and operating conditions and times for the cleaning unit C during cleaning operations. Such a computer may be a laptop or notebook computer, although it should be understood that other forms of computers may also be used.

The cleaning unit C includes a drive or transport mechanism to move the transport chassis S. The drive mechanism is preferably in the form of front drive wheels 90 which are mounted with the transport chassis S at front end portions of the transport chassis and are connected by a front drive axle 92. Rear drive wheels 94 of the drive or transport mechanism are mounted with the transport chassis S at rear end portions of the transport chassis and are connected by a rear drive axle 96. The drive wheels 90 and 94 are preferably provided with suitable tread patterns, such as the herringbone pattern shown, for gripping and engagement of the interior surface of the tank floor during movement of the unit C into position for cleaning. The vertical height dimensions of the wheels 90 and 94 and the chassis S are typically on the order of from six to nine inches.

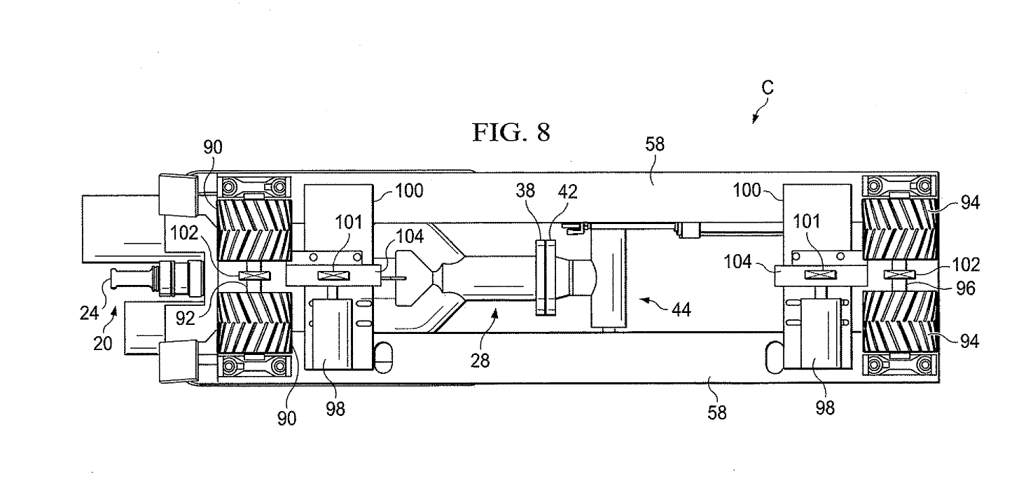

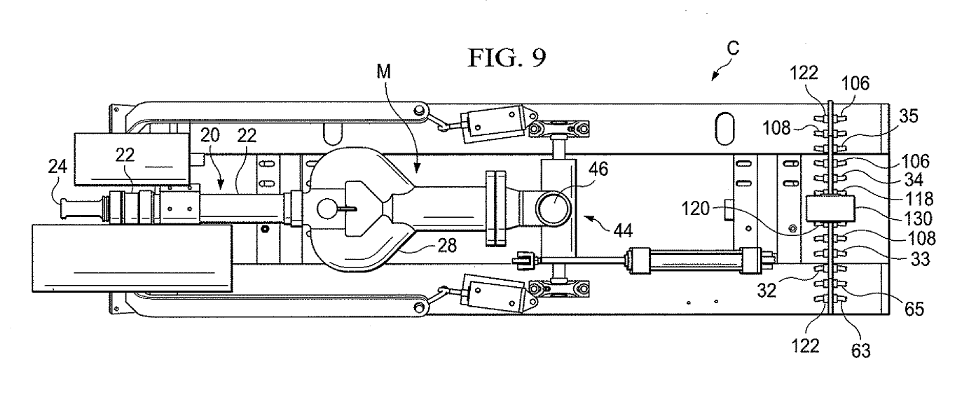

Drive motors 98 are mounted below (FIG. 8) support plates 100 which laterally between the side beam members 58 of the transport chassis S. Although it is preferable that drive motors 98 be present at both the front and rear ends of the chassis as shown, in some cases only one may be needed. The drive motors 98 are connected through a power transfer mechanism in the form of sprocket gears shown schematically at 101 through a chain belt or other form of belt to drive the drive wheels 90 and 94 through sprocket gears shown schematically at 102 on their respective drive axles 92 and 96. The power transfer mechanism of sprocket gears 102 and associated drive belts powers the drive wheels 90 and 94 moves the tank cleaning unit C.

The sprocket gears 102 and associated drive chain or belt are preferably mounted within a guard assemblies 104 mounted beneath the transport chassis S. The guard assemblies 104 protect the drive gears 102 and associated structure from damage by debris or other materials in the circulating material in the storage tank during tank cleaning.

The drive motors 98 are preferably solenoid activated, hydraulically powered motors which receive operating power from supply conduits 106 and 108 connected from the control system to the chassis S to move the cleaning unit C within the storage tank. The forward or reverse direction of movement of the unit C is controlled by the direction of flow of hydraulic power fluid through conduits 106 and 108.

Initially, the clearing unit enters the storage tank in the entry position shown in FIG. 6 the operator controls the spray nozzle 24 on entry into the storage to begin to clear a path in initial portion of the accumulated sludge in the tank adjacent the entry manway. The chassis S is moved by the operator under control of the drive motors 98, and the chassis and cleaning module M are moved to a central location within the tank along a path cleared by the nozzle 24 during such movement. The nozzle 24 may be steered and raised or lowered as desired as the unit C is moved to the center of the tank to clear a path with the cutter fluid spray.

As the path is cleared, the cleaning unit C moves to the center of the tank. The cleaning unit C is then in a position to clean the remainder of the storage tank without traveling any farther. The unit C in the central position on the floor of the storage tank is in position for spraying, and there is no need move about tank with the present invention. By positioning the cleaning unit C in the center of the tank, the distance to spray cutter stock is significantly reduced making it much more effective. This, in turn, reduces the amount of cleaning fluid or cutter stock required and reduces overall cleaning costs.

The effluent mixture of cleaning and sludge are pumped away from the center of the storage tank by pumps separate from the cleaning unit C, allowing for more effective suction near the man ways. There is no need for pickup of the effluent by the tank cleaning unit C, the fluid connection withdrawal and drainage system which is installed as part of the storage tank carries off the effluent sludge and cleaning fluid mixture.

Lateral stabilizer arms or outriggers 110 are mounted with the transport chassis S on each of the side beam members 58. The stabilizer arms 110 have enlarged support pads or contacts 112 for engagement with the floor of the cleaning tank. The stabilizer arms 110 are connected by pivoting linkages 113 to outer ends of piston shafts 114 which are operated by stabilizer actuator pistons 116. The pistons 116 are each hydraulically driven and solenoid actuated assemblies by their respective associated control lines 118 and 120 from the control system S. Each of the pistons 116 operates under control of and receives power from its associated control lines 118 and 120 to move the linkages 113, and thus pivot stabilizer arms 110, outwardly. The stabilizer arms 110 in their extended positions furnish lateral stability for the tank cleaning unit C in the storage tank. The stabilizer arms 110 on the chassis S provide stability as a preventative measure. The stabilizer arms 110 reduce the risk of the cleaning unit C unit tipping over. It is common practice for storage tanks to have some form of sloped floor, and at times the grade of such a slope may give rise to a situation that might where stability of the unit against tipping over or overturning may be a concern. The cleaning unit C has a large amount of mass and a low center of gravity to help prevent the unit from overturning. The stabilizers 110 are included to also provide additional support in the case the unit becomes unstable due to cannon spray forces.

The vertical height dimensions of the wheels 90 and 94 and the chassis S are typically on the order of a normal depth of sludge encountered in a storage tank, with a typical sludge depth in a tank being on the order of eighteen inches or so.

As can be seen there are several components and assemblies of the tank unit which are connected by conduits or conductors to the control system for provision of control functions and transfer of operating power. The following is a list of conduits or conductors and their association with components in an example connection arrangement:

| | |
|---|---|
| Nozzle 24 - Left or Right | Conduits 32 and 33 |
| Nozzle 24 - Up or Down | Conduits 34 and 35 |
| Module M - Up or Down | Conduits 63 and 65 |
| Illumination Source 70 | Conduit 78 |
| Camera 80 | Conduit 82 |
| Drive Motors 98 | Conduits 106 and 108 |
| Stabilizers 110 - In and Out | Conduits 118 and 119 |
| (Two Sets) | (Two Sets) |

As can be seen, there are at least fourteen conduit or connections between the cleaning unit C and the control system S. According to the present invention, a conduit support frame 120 is mounted extending upwardly from the chassis S rearward of the cleaning module M. The conduit support frame 120 supports the conduits and conductors extending between the chassis S and the control system K at spaced positions from each other. A group of couplings 122 are mounted at assigned designated locations in conduit support frame 120 to receive individual assigned ones of the conduits and conductors listed above. The entirety of the conduits and conductors and in particular those portions between the conduit support frame 120 and the cleaning module M are not shown in the drawings so that other structure of the tank cleaning unit C may be seen. FIG. 3 illustrates schematically an example arrangement of the conduits and conductors and the couplings 122 on the support frame 120.

The conduit support frame 120 and couplings 122 serve to bring the connections to a common point on the cleaning unit. This also provides alignment and prevents tangling of the various conduits and conductors. The arrangement of the couplings 122 on the frame 120 is preferably labeled as an installation and connection guide during connection of the cleaning unit to the control system K. The conduit support frame 120 also has an arcuate surface 124 formed on a lower central portion for ease of passage of the cleaning fluid supply hose 50.

The present invention reduces costs by reducing cleaning time and returning the tank for service much more quickly than available conventional cleaning methods. The cleaning unit C can be installed through one manway into the storage tank and the remote control system operator can direct the cleaning unit C to the center of the storage tank and control the orientation of the unit to spray and clean the entire tank with the nozzle 24. The fluid from the nozzle 24 forces the fluid and sludge in the storage tank being cleaned to the outside portions of the tank interior, making fluid suction and removal much simpler and faster.

The tank cleaning unit C also includes a rear view camera 130 mounted in a vapor sealed, explosion proof, corrosion proof housing mounted on the conduit support frame 120. A suitable camera is a Det-Tronics X7050 model, available from Detector Electronics Corporation. The rear view camera is mounted on the frame 120 to provide a rear view and form a reference view, as well as additional viewing of internal conditions and progress of tank cleaning operations. The rear view camera 130 is connected for control, power supply and signal transfer purposes by connectors in the same conduit 82 which connects the camera 80 to the control system K.

The invention has been sufficiently described so that a person with average knowledge in the matter may reproduce and obtain the results mentioned in the invention herein Nonetheless, any skilled person in the field of technique, subject of the invention herein, may carry out modifications not described in the request herein, to apply these modifications to a determined structure, or in the manufacturing process of the same, requires the claimed matter in the following claims; such structures shall be covered within the scope of the invention.

It should be noted and understood that there can be improvements and modifications made of the present invention described in detail above without departing from the spirit or scope of the invention as set forth in the accompanying claims,

What is claimed is:

1. A tank cleaning unit movable within a storage tank and applying cleaning fluid to waste material in the tank to clean the tank under control of a remote control system located externally of the storage tank, comprising:
a cleaning module, comprising:
a cleaning fluid applicator receiving cleaning fluid through a fluid supply connection and spraying cleaning fluid into the waste material for cleaning purposes;
an illumination source mounted with the cleaning fluid applicator, the illumination source emitting light into an area of the tank being sprayed with cleaning fluid from the cleaning fluid applicator, the illumination source being connected by an electrical supply conduit from the control system to receive operating power;
an observation camera forming images of the area of the tank being sprayed with cleaning fluid from the cleaning fluid applicator, the observation camera being connected an electrical supply conduit to the control system to receive operating power and control signals;
the observation camera being connected by a signal transfer conduit to convey to the control system images of the area of the tank being sprayed;
a transport chassis for supporting the cleaning fluid module;
a drive mechanism mounted with the transport chassis moving the chassis;
at least one drive motor mounted with the transport chassis and moving the front and rear drive mechanism;
the drive motor receiving operating power from a supply conduit connected from the control system to the transport chassis to move the transport chassis and cleaning module within the interior of the tank;
a power transfer mechanism mounted with the transport chassis between the drive motor and the drive mechanism;
the cleaning module being movable with respect to the transport chassis from a lowered position for entry into the tank to a raised position for cleaning purposes;
a position adjustment mechanism mounted between the cleaning module and the transport chassis for moving the cleaning module between the lowered and raised positions, the position adjustment mechanism receiving operating power from a supply conduit connected from the control system to the transport chassis; and
a conduit support frame mounted with the transport chassis and supporting the conduits extending between the transport chassis and the control system at spaced positions from each other during movement of the cleaning module and transport chassis.

2. The tank cleaning unit of claim 1, further including:
a rear view camera forming images of the area to the rear of the cleaning module;
the rear view camera being connected an electrical supply conduit to the control system to receive operating power and control signals;
the rear view camera being connected by a signal transfer conduit mounted with the conduit support frame and conveying to the control system images of the area to the rear of the cleaning module.

3. The tank cleaning unit of claim 1, further including:
lateral stabilizers mounted with the transport chassis and being movable outwardly to furnish lateral stability for the tank cleaning unit in the storage tank;
the lateral stabilizers receiving operating power from a supply conduit connected from the control system to the transport chassis and mounted with the conduit support frame.

4. The tank cleaning unit of claim 1, further including:
a fluid manifold transferring cleaning fluid to the cleaning fluid applicator;
a fluid transfer chamber connecting the fluid supply connection and the fluid manifold; and
the fluid transfer chamber being movable by the position adjustment mechanism with respect to the transport chassis during movement of the cleaning module between the lowered and raised positions.

5. The tank cleaning unit of claim 1, further including the drive motor being connected by drive motor control conduits to the remote control system for control of movement of the transport chassis within the storage tank, the drive motor control conduits being mounted with the conduit support frame.

6. A tank cleaning unit movable within a storage tank and applying cleaning fluid to waste material in the tank to clean the tank under control of a control system located externally of the storage tank, comprising:
a cleaning module, comprising:
a cleaning fluid applicator receiving cleaning fluid through a fluid supply connection and spraying cleaning fluid into the waste material for cleaning purposes;
an illumination source mounted with the cleaning fluid applicator, the illumination source emitting light into an area of the tank being sprayed with cleaning fluid from the cleaning fluid applicator, the illumination source being connected by an electrical supply conduit from the control system to receive operating power;
an observation camera forming images of the area of the tank being sprayed with cleaning fluid from the cleaning fluid applicator, the observation camera being connected an electrical supply conduit to the control system to receive operating power and control signals;
the observation camera being connected by a signal transfer conduit to convey to the control system images of the area of the tank being sprayed;
a transport chassis for supporting the cleaning fluid module;
a drive motor moving the transport chassis and cleaning module within the interior of the tank;
the cleaning module being movable with respect to the transport chassis from a lowered position for entry into the tank to a raised position for cleaning purposes;
a position adjustment mechanism mounted between the cleaning module and the transport chassis for moving the cleaning module between the lowered and raised positions, the position adjustment mechanism receiving operating power from a supply conduit connected from the control system to the transport chassis; and
a conduit support frame mounted with the transport chassis and supporting the conduits extending between the transport chassis and the control system at spaced positions from each other during movement of the cleaning module and transport chassis.

7. A tank cleaning unit movable within a storage tank and applying cleaning fluid to waste material in the tank to clean the tank under control of a control system located externally of the storage tank, comprising:
a cleaning module, comprising:
a cleaning fluid applicator receiving cleaning fluid through a fluid supply connection and spraying cleaning fluid into the waste material for cleaning purposes;
an illumination source mounted with the cleaning fluid applicator, the illumination source emitting light into an area of the tank being sprayed with cleaning fluid from the cleaning fluid applicator, the illumination source being connected by an electrical supply conduit from the control system to receive operating power;
an observation camera forming images of the area of the tank being sprayed with cleaning fluid from the cleaning fluid applicator, the observation camera being connected an electrical supply conduit to the control system to receive operating power and control signals;
the observation camera being connected by a signal transfer conduit to convey to the control system images of the area of the tank being sprayed;
a transport chassis for supporting the cleaning fluid module;
a power transfer mechanism mounted with the transport chassis between the drive motor and the front and rear drive axles;
the cleaning module being movable with respect to the transport chassis from a lowered position for entry into the tank to a raised position for cleaning purposes;
a position adjustment mechanism mounted between the cleaning module and the transport chassis for moving the cleaning module between the lowered and raised positions, the position adjustment mechanism receiving operating power from a supply conduit connected from the control system to the transport chassis;
lateral stabilizers mounted with the transport chassis and being movable outwardly to furnish lateral stability for the tank cleaning unit in the storage tank;
the lateral stabilizers receiving operating power from a supply conduit connected from the control system to the transport chassis; and
a conduit support frame mounted with the transport chassis and supporting the conduits extending between the transport chassis and the control system at spaced positions from each other during movement of the cleaning module and transport chassis.
